(19) United States
(12) Patent Application Publication
(10) Pub. No.: US 2022/0309411 A1
(43) Pub. Date: Sep. 29, 2022

(54) BUSINESS PROCESS ANALYSIS

(71) Applicant: Microsoft Technology Licensing, LLC, Redmond, WA (US)

(72) Inventors: Sanjay Hemmige RAMASWAMY, Redmond, WA (US); Jagadeesh Virupaksha HULIYAR, Redmond, WA (US); Umashree NARAYANASWAMY, Redmond, WA (US); Nicholas Christman BLAKELY, Redmond, WA (US); Ananthatejas RAGHAVAN, Redmond, WA (US); Joseph Robert FORSMAN, Norman, OK (US); Tapas BANSAL, Bellevue, WA (US); Sang Pom SIN, Seattle, WA (US); Abhijeet PAREEK, Bothell, WA (US); Anish RAVI, Raleigh, NC (US); Omar Suhaib MUSTAFA, Redmond, WA (US); Nikhita GOYAL, Bothell, WA (US)

(21) Appl. No.: 17/214,293

(22) Filed: Mar. 26, 2021

(51) Int. Cl. G06Q 10/06; G06F 40/289; G06Q 10/10

(52) U.S. Cl. CPC G06Q 10/067; G06F 40/289; G06Q 10/103; G06Q 10/063114

(57) ABSTRACT

The systems and methods may provide users with an interactive way to form a definition of a business process and later use the business process definition to get a variety of metrics that quantify process cost for the specified process and help users understand how much collaboration happened for a specific process. The systems and methods may also provide capabilities to refine or streamline the business processes for efficiency.

### BACKGROUND

Companies today have a lot of business processes going on, such as, planning, hiring, training, live site, action-oriented meetings, etc. Analysts in these companies are interested in understanding and analyzing the collaboration patterns for specific business processes. Analysts are trying to understand how various processes are executing within their company and how much resources these processes consume. A first challenge companies face is to establish a baseline around costs of processes, a second challenge companies face is to monitor or operationalize such processes, and another challenge companies face is around actionability where companies may have the opportunity to streamline or adjust for efficiency. Currently, this type of analysis has been possible to a limited extent by manually examining meeting and/or email content (subject line only) to see if there is a match with a certain process. Due to data volumes, and lack of full context on the process, the results are guess-work at best.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a system. The system may include a memory to store data and instructions; at least one processor operable to communicate with the memory, wherein the at least one processor is operable to: receive at least one initial word that describes a business process to include in a business process definition for the business process; present, via a user interface, related words for the business process, wherein the related words are received from an inference model that is accessed in response to a selection of a dataset of filtered collaboration data to use in creating the business process definition; present, via the user interface, coverage information that identifies an amount of collaboration data that includes the related words and the at least one initial word; receive one or more additional words from the related words to include in the business process definition; and generate and store the business process definition with a set of included words that describe the business process, wherein the set of included words includes the at least one initial word and the one or more additional words.

Some implementations relate to a method for creating a business process definition. The method may include receiving at least one initial word that describes a business process to include in a business process definition for the business process. The method may include presenting, via a user interface, related words for the business process, wherein the related words are received from an inference model that is accessed in response to a selection of a dataset of filtered collaboration data to use in creating the business process definition. The method may include presenting, via the user interface, coverage information that identifies an amount of collaboration data that includes the related words and the at least one initial word. The method may include receiving one or more additional words from the related words to include in the business process definition. The method may include generating and storing the business process definition with a set of included words that describe the business process, wherein the set of included words includes the at least one initial word and the one or more additional words.

Some implementations relate to a method for business process analysis. The method may include receiving a set of filters that define a dataset of filtered collaboration data. The method may include using the filtered collaboration data as an input to train an inference model to determine related words using the filtered collaboration data. The method may include using the related words from the inference model to create a business process definition for a business process. The method may include adding a business process tag to collaboration data that belongs to the business process based on the business process definition. The method may include generating results to one or more queries for the business process, wherein the results include collaboration data with the business process tag for the business process. The method may include causing the results for the one or more queries for the business process to be presented, via a user interface, to aid in one or more business processes analysis on the collaboration data.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example system for use with business process analysis in accordance with implementations of the present disclosure.

FIG. 2 illustrates an example inference service for use with implementations of the present disclosure.

FIG. 3 illustrates an example method for business process analysis in accordance with implementations of the present disclosure.

FIG. 4 illustrates an example method for creating a dataset in accordance with implementations of the present disclosure.

FIG. 5 illustrates an example method for creating a business process definition in accordance with implementations of the present disclosure.

FIG. 6 illustrates an example method for tagging collaboration data in accordance with implementations of the present disclosure.

FIG. 7 illustrates an example method for generating query results in accordance with implementations of the present disclosure.

FIG. 8 illustrates an example graphical user interface (GUI) screen for creating a new dataset for use with implementations of the present disclosure.

FIGS. 9 and 10 illustrate example GUI screens for creating a new business process definition for use with implementations of the present disclosure.

FIG. 11 illustrates an example GUI screen for generating a query for use with implementations of the present disclosure.

### DETAILED DESCRIPTION

This disclosure generally relates to business process analysis. Companies today have a lot of business processes going on, such as, line of business processes, backend processes, administrated related activities, coaching, mentorship, planning, hiring, training, live site, action-oriented meetings, etc. A challenge companies have is that companies are unaware of how much time is spent on various processes running within the companies. For example, companies are unaware if the various processes are operating smoothly as expected or if changes may be required to streamline or optimize the processes. As such, a first challenge companies face is to establish a baseline around costs of processes, a second challenge companies face is to monitor or operationalize such processes, and another challenge companies face is around actionability where customers may have the opportunity to streamline or adjust for efficiency.

Currently, companies may use a plethora of metrics to try and understand what collaborative trends exist in a company and how they impact overall productivity and effectiveness. However, current metrics are content-agnostic. Current metrics do not consider data aspects of collaboration, such as, subject and body content of emails and/or meetings, body of instant messages (e.g., SKYPE or TEAMS messaging), etc. Moreover, typical analysis tools analyze data based on machine generated mail, not on human generated data.

Collaborations and/or discussions for the different business processes generally occur between different individuals using a variety of platforms, such as, but not limited to, meetings, e-mail, document collaboration, and/or instant messaging.

The present disclosure provides a wholistic view of the collaboration data for the business process (e.g., a wholistic view of the collaboration data gathered or received from the various platforms used in collaborations and/or discussions for the business process). Collaboration activities or collaboration items for a business process may include, but are not limited to, meetings, electronic chats, text messaging, e-mails, and/or document collaborations between individuals (e.g., individuals of an organization). Collaboration data may include any type of electronic documents with human generated text relating to collaborations activities, collaboration items, and/or discussions of the business process, such as, but not limited to information received from meetings discussing the business process, e-mails about the business process, electronic chats about the business process, instant messages discussing the business process, document collaborations for the business process, and/or information received from calendar data (e.g., subject lines of meetings, body of the meeting invites, attendees, meeting times, meeting places for meetings about the business process, and/or an amount of time scheduled for a meeting). Collaboration data may be specific to the company. The present disclosure quantifies the business process into numbers that may convey how much the business process costs (e.g., the amount of hours spent on the business process or the cost dollars (rate per person per hour)) and provides a baseline for the business process.

The present disclosure provides methods and systems for allowing users to easily define processes of interest and get a variety of metrics that quantify process cost for the specified process, via, for example a dashboard. The methods and systems may also provide capabilities to refine and/or streamline these processes for efficiency.

The methods and systems may characterize human generated mails, meetings, and/or chats (e.g., collaboration data) by business process and may use the collaboration data created by the users in a company for one or more business process analyses. In some implementations, users (e.g., individuals of an organization) may have to explicitly opt into data collection and/or the users can opt out of data collection. The methods and systems may provide users with an interactive way to form a definition of a business process and later use the business process definition to understand how much collaboration happened for a specific process.

A business process definition is as a collection of words that describe a business process. Any collaboration activity or items that contain the words of the business process may belong to the business process definition. As such, any time spent on the collaboration activity or item may be included in the amount of time spent on the business process.

Today there are multiple models available that can be trained based on some data and given a word, and the models can identify or match related words to the word. Models today may use fully unsupervised or supervised data (person selects meetings and marks them as belonging to a process or does not belong to a process) for the training. The present disclosure uses a semi supervised machine learning model that receives a given input word or set of input words for a business process and provides related words to the input word(s). The present disclosure drives a user through a series of steps to identify more words related to the business process. Different weights may be applied to the words provided by the users to determine additional related words. For example, a higher priority or weight may be given to words provided by the user in a later round relative to a word provided as the initial word or near the start of the iterations.

For example, a user may want to find out how much time a company is spending around moral activities. The user may only know one or two words for moral activities in the company. The present disclosure guides the user through multiple iterations of related words to drive users in a correct direction to identify majority of the words available for moral activities in the company.

One technical improvement of the present disclosure is determining what words are related words for a business process. Words may have different meanings depending on the context, and thus, different related words may be provided for the same word depending on the context of the word. For example, the word “apple” can mean fruit, or a company, and the related words may change based on the context. Mangos or oranges may be provided as related words when apple is in the context of fruit. Other technology companies may be provided as related words when apple is in the context of a company or product. As such, determining related words for a given context can be difficult.

Another technical improvement of the present disclosure is providing an interactive process in creating the business process definitions. The present disclosure uses separate inference models for different contexts and/or different business processes for providing the related words. As such, a large number of inference models may be hosted and used in creating the different business process definitions.

Current business process analysis is typically performed through analysis of template information. For example, e-mails that are machine generated have some structured templates in the e-mails. Current business analysis use the structured templates to understand what e-mail belongs to which business process.

Another technical improvement of the present disclosure includes the analysis of human generated collaboration data (e.g., e-mails, documents, instant messages, and/or information received from calendar data), which does not have predefined structures. The present disclosure analyzes the non-structured data and uses the analysis to understand how much time a company is spending on a business process.

The present disclosure enables users to define a scoped dataset to use for training one or more inference models, so as to drive relevant and/or targeted process analysis. A user will select which dataset the user wants to use for creating a business process definition for a business process. One example use case is the user is a CEO for a company and wants to analyze a business process for customer interactions. The CEO may only want to analyze how much time individuals within the sales team are spending on customer interactions. As such, the CEO may specify that the dataset to use is only the data relating to individuals on the sales team.

The scoped dataset is used to train an inference model to help the user come up with a business process definition. The inference models are based on the collaboration data (discussions or conversations) in the filtered dataset. The inference model creates an internal mapping of which words are closer to each other versus other words in the collaboration data. Each model is tied to a different dataset. As such, a different inference model is created for every filtered dataset. The filtered dataset may identify a group of related conversations. When a user enters in a seed word for a business process, the inference model provides other options for the seed words (related words) that appears in the same context as the seed word, and thus, may be part of the same business process.

One model may be used for different business process definitions. For example, if the scoped dataset is for the sales team in a company, the inference model corresponds to the dataset for the sales team in the company. Various business process definitions may be created for the sales team, such as, but not limited to, customer interactions, employee moral events, promotions, reviews, hiring, and/or training. As such, the inference model for the sales team may be used to create one or more business process definitions.

Once the inference models are generated, they are ready for use in preparing business definitions for a business process. The user may provide a seed word or phrase “customer interview” for the business process definition. The inference models are loaded for a real time process. By using inference models, a hint via a single keyword can help uncover numerous related keywords or phrases, that may have been difficult or impossible to uncover manually.

Using the hosted models, the user comes up with a business process definition with included words and/or excluded words. When the business process definition is complete (e.g., the user does not want to add or remove any more words), the business process definition is stored. The business process definition will be available for use. With this automated interactive approach, a business process may be captured more accurately and comprehensively. Moreover, the inference models provide a streamlined experience without noisy content, enabling an effective process definition capture.

Once the business process definitions are created for the business processes, the collaboration data is tagged when it matches a defined business process, enabling on-demand querying. Tagging may also enable downstream applications and/or services to use the tagged collaboration data. Once the collaboration data is tagged, the user may use a flexible query system that allows the user to filter individuals, business processes, time frames, collaboration data types (meeting, e-mails, documents, instant messaging), and/or optimizations.

The users may run a variety of queries on processes to estimate process cost around metrics, such as, but not limited to, meetings time spend, people involved, and/or generated workload. The queries and/or metrics may be operationalized in a custom dashboard or report templates for ready use and/or monitoring. The tagged collaboration data may also be packaged to deliver metrics and insights into processes, such as, administrator logistics, training, and/or coaching, based on common keyword vocabulary, thus, making the tagged content accessible to a broader set of users.

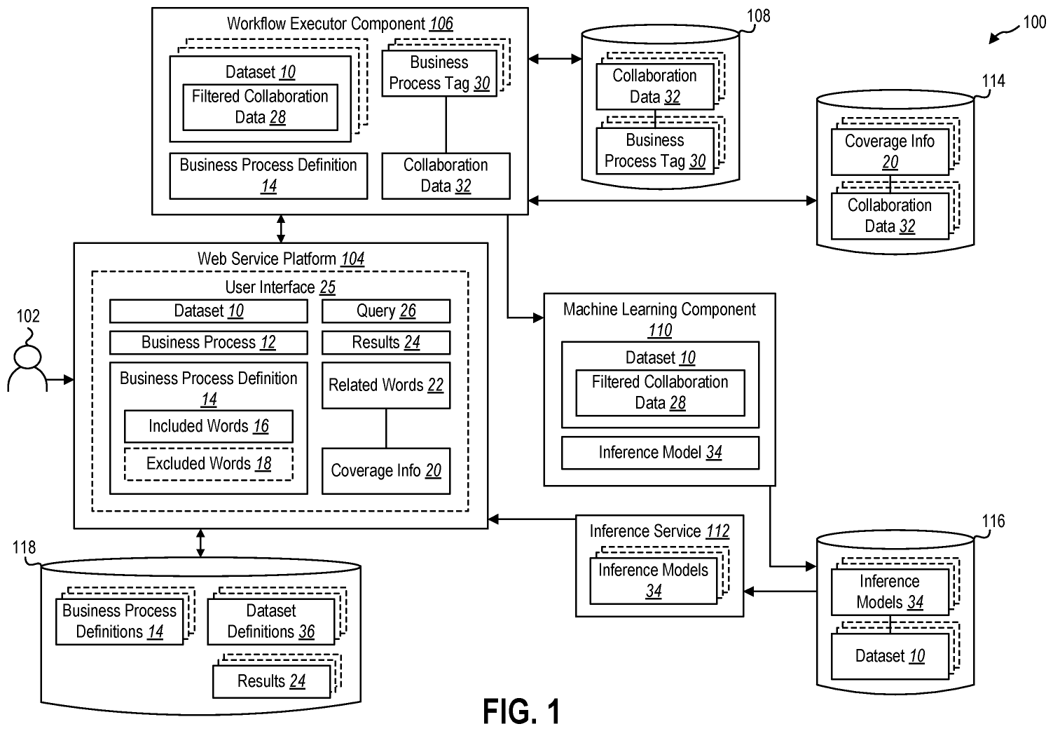

Referring now to FIG. 1, illustrated is an example system 100 for use with business process analysis. System 100 may be implemented by a cloud service provider. System 100 may include a web service platform 104 that one or more users 102 may access. Users 102 may include, but are not limited to, analysts and/or employees of an organization or company.

The web service platform 104 may provide a centralized business process management experience for the users 102. The web service platform 104 may include a user interface 25 that provides the capability for the users 102 to create datasets 10, business process definitions 14 for business processes 12, and/or use the business processes definitions 14 for determining the collaboration patterns in a company or an organization. A user 102 may access the web service platform 104, for example, through a portal or dashboard and may use the web service platform 104 for one or more activities related to business process analysis.

The user 102 may use the user interface 25 to identify one or more business processes 12 for an organization or company and/or perform various analysis on the business processes 12. Business process 12 may include any activity performed in the company including, but not limited to, line of business processes, backend processes, administrated related activities, coaching, mentorship, planning, hiring, training, live site, and/or action-oriented meetings. For example, the user 102 may use the web service platform 104 to perform analysis on the collaboration data 32 to determine how many meetings are spent planning events for the company.

In addition, the user 102 may use the user interface 25 to create a business process definition 14 for a business process 12. The business process definition 14 may be a collection of words that describe a business process 12. The business process definition 14 may include a list of included words 16 and may include a list of excluded words 18 that describe the business process 12. The web service platform 104 may provide an interactive tool for creating the business process definition 14.

The user 102 may also use the user interface 25 to identify or define different datasets 10 to use in the business process analysis and/or to use when creating the business process definitions 14 for different business processes 12. An example dataset 10 definition is “meetings data of all sales individuals for the last 3 months.”

Collaboration data 32 for various users 102 of the system 100 may be stored in one or more datastores 108. The collaboration data 32 may be data gathered or saved from a plurality of companies relating to business processes 12. The collaboration data 32 may include any electronic documents with human generated text relating to collaborations or discussions of the business process 12. Examples of collaboration data 32 include, but are not limited to, information received from electronic meeting invites or calendar data (e.g., subject lines, attendee information, text from the body of the invite, and/or an amount of time scheduled for the meeting), e-mails about the business process, instant messages discussing the business process, documents generated for the business process, and/or electronic chats discussing the business process.

The collaboration data 32 may be stored in one or more datastores 108 per user of the system 100 or per company. Users from one company may be unable to access collaboration data 32 from another company. As such, only the collaboration data 32 associated with the user 102 (e.g., the collaboration data for the user's company) may be used in creating the scoped datasets 10 and/or the business process definitions 14 for the user 102.

The dataset 10 definition may be sent to the workflow executor component 106. The workflow executor component 106 may identify a set of filtered collaboration data 28 that corresponds to the dataset 10 definition. The filtered collaboration data 28 may identify a group of related collaboration data 32. For example, the group of related collaboration data 32 is obtained from electronic information or documents obtained from a group of related e-mail messages, a group of related text messages, and/or a group of related electronic chats. As such, the filtered collaboration data 28 may be a subset of all the collaboration data 32 tailored to the context of the dataset 10 definition.

The workflow executor component 106 may send the dataset 10 and the filtered collaboration data 28 to the machine learning component 110 to use as input data in training one or more machine learning inference models 34. Each dataset 10 may correspond to the filtered collaboration data 28 of a single dataset 10, and the inference models 34 may be based on the filtered collaboration data 28 (discussions or conversations) in the dataset 10. As such, each inference model 34 may be tied to a different dataset 10.

By providing a well-defined dataset 10 as training input for the inference models 34, the inference models 34 may produce better results. Often times the same word can mean different things in different contexts, hence having a well-defined input data is beneficial in defining the context of the datasets 10. For example, the word “forecast” may mean inventory forecasting in supply chain teams and company profit forecasting in finance teams. As such, by narrowing down which collaboration data 32 to use based on the context of the dataset 10, the inference model 34 may be able to provide more accurate related words 22.

The machine learning component 110 may generate one inference model 34 for each dataset 10. The inference model 34 may create an internal mapping of which words are closer to each other versus other words in the filtered collaboration data 28. As such, the inference models 34 may be customized to the context of the corresponding dataset 10.

In an implementation, the inference models 34 is a trained machine learning model customized for the filtered collaboration data 28 of the dataset 10. Examples of the machine learning model include, but are not limited to, word2vec models, sent2vec models, (Bidirectional Encoder Representations from Transformers) BERT models, and/or Embeddings from Language Models (ELMO). The inference models 34 may be trained to find related words (bigrams included). In some implementations, the inference models 34 may be trained for different languages (e.g., French, Spanish, Chinese, etc.). The inference models 34 run through the dataset 10 and determines which words are close to one another in meaning. Words that have similar meanings to each other may have a lesser distance to each other as compared to words that are different in meaning (e.g., words with different meanings may have a larger distance between each other).

The machine learning component 110 may use various techniques to train the inference models 34 to merge results of the related words and rank the results based on words selected by the user 102 during the business process definition 14 creation. In addition, the machine learning component 110 may use customized noise reduction techniques specific to human curated collaboration data 32. For example, the inference models 34 may filter out noise, such as, but not limited to, soft words, unrelated words, meaningless bigrams, dates, names, and/or months. The machine learning component 110 may also use a custom way to prioritize results based on how and when a word was added into the business process definition 14. As such, the inference models 34 may provide a streamlined experience without noisy content, enabling an effective process definition capture.

The inference models 34 generated by the machine learning component 110 may be stored in one or more datastores 116. In an implementation, an association between the corresponding dataset 10 may be stored in the datastore 116 with the inference model 34. As new datasets 10 are created, new inference models 34 may be created by the machine learning component 110 for the new datasets 10. As such, separate machine learning inference models 34 for different context and/or different scoped datasets 10 may be stored in datastore 116.

The inference service 112 provides a platform for hosting the inference models 34 when needed for building a business process definition 14. For example, one or more datasets 10 may be selected for creating a new business process definition 14. The user 102 may select one or more datasets 10 to use when creating the business process definition 14 for a business process 12. One example use case is the user 102 is a CEO for a company and the user 102 wants to analyze a business process for customer interactions. The user 102 may only want to analyze how much time individuals within the sales team are spending on customer interactions. As such, the user 102 may specify that the datasets 10 to use is the datasets 10 relating to individuals on the sales team. In addition, the user 102 may specify one or more seed words as initial words describing the business process 12.

The inference service 112 may load one or more inference models 34 from the datastore 116 associated with the selected datasets 10 and the inference services 112 may use the loaded inference models 34 to provide related words 22 for use when creating the business process definition 14. The inference models 34 may determine if there is another word that is close to the seed word in this context (e.g., words that are similar in meaning may have a lesser distance to each other as compared to words that are different in meaning, which may have a greater distance to each other). The inference models 34 may be loaded on demand to provide interactive capability for defining the business processes 12. Only active inference models 34 may be loaded into the inference service 112, and thus, optimizing resource usage of the inference service 112.

As such, the inference service 112 provides an on demand and interactive process for loading the appropriate inference models 34. By hosting multiple inference models 34 on demand, the inference service 112 enables interactive, on demand inference machine learning models loading at a low cost, helping to eliminate huge model load times.

The web service platform 104 may cause the list of related words 22 received from the inference service 112 to display via the user interface 25 to the user 102. In addition, the web service platform 104 may cause the coverage information 20 for the related words 22 to display via the user interface 25. The coverage information 20 may provide information on the amount of collaboration data 32 that includes the related word 22. For example, the coverage information 20 may provide information about how many meetings include the related word 22 (e.g., how many electronic meeting invites and/or calendar information include the related word 22). Another example of the coverage information 20 includes information about the number of hours spent in meetings that included the related word 22. The coverage information 20 may assist the user 102 in creating better business process definitions 14 by allowing the user to select and/or exclude words based on the amount of collaboration data 32 that may be included and/or excluded from the analysis.

The workflow executor component 106 may be used to determine the coverage information 20. For example, the workflow executor component 106 processes information from the collaboration data 32, such as, but not limited to, a number of meetings invitations or calendar information that include the related word 22, meeting hours (e.g., an amount of time scheduled for the meetings that include the related word 22), and/or similar metrics to provide an indication on how frequently a word and/or phrase is used in the collaboration data 32. The coverage information 20 may be stored in a datastore 114.

The user 102 may use the list of related words 22 and/or the coverage information 20 to add additional words to the business process definition 14 and/or remove words from the business process definition 14. As such, the business process definition 14 may include a set of included words 16 that describe the business process 12 and/or a set of excluded words 18. Once the business process definition 14 is formed, the business process definition 14 may be stored in datastore 118. The stored business process definitions 14 may be used in analyzing the collaboration data 32.

The business process definition 14 may also be published for use by other components and/or applications in system 100. The workflow executor component 106 may receive or access the business process definitions 14 and may use the business process definitions 14 to identify which collaboration data 32 may be related to the business process 12.

The workflow executor component 106 may access the collaboration data 32 stored in the datastore 108 and may determine whether any words or phrases in the collaboration data 32 match the business process definition 14. If a match occurs between the words or phrases in the business process definition 14 and the collaboration data 32, the workflow executor component 106 may add, or otherwise associate, a business process tag 30 to the collaboration data 32. The business process tag 30 may be used to identify which collaboration data 32 may be related to the business process 12.

As new collaboration data 32 is added to the datastore 108, the workflow executor component 106 may add one or more business process tags 30 to the new collaboration data 32. In an implementation, the workflow executor component 106 may periodically add business process tags 30 to the collaboration data. One example may include the workflow executor component 106 checking weekly for any new collaboration data 32 added to the datastore 108 and may add one or more business process tags 30 to any new collaboration data 32 added within the week.

The business process tags 30 may be used to generate results 24 to queries 26 by the user 102 to analyze the impact of the business process 12 to the company. The user 102 may generate one or more queries 26 for a business process 12. The queries 26 may identify the business process definitions 14 for the business process 12. In addition, the queries 26 may exclude different business process definitions 14 and/or business processes 12 from the analysis. For example, the user 102 may create a query 26 to identify how much time the company is spending in meetings planning events.

The web service platform 104 may execute the query 26 against the one or more datastores 108, 114, 116, 118 of the system 100 to obtain the results 24 for the query 26. In addition, the web service platform 104 may communicate the query 26 and the business process and/or the identified business process definitions 14 for the query 26 to the workflow executor component 106. The workflow executor component 106 may execute the query 26 against the datastores 108, 114, 116, 118 of the system 100 to obtain the results 24 for the query 26. For example, the workflow executor component 106 may use the business process tags 30 to identify which collaboration data 32 in the datastore 108 is related to the identified business process definitions 14 and provide the identified collaboration data 32 may be provided to the web service platform 104.

The web service platform 104 may provide results 24 to the query 26 using the identified collaboration data 32 received from the workflow executor component 106. The results 24 may be presented to the user 102 via the user interface 25 and/or the results 24 may be stored in the datastore 118 for future analysis or use. The results 24 may provide the user 102 an overview of the collaboration time spent on a business process 12. In addition, the results 24 may help the user 102 understand how much collaboration happened for a specific business process 12.

Each of the components of the system 100 may be in communication with each other using any suitable communication technologies. In addition, while the components of the system 100 are shown to be separate, any of the components or subcomponents may be combined into fewer components, such as into a single component, or divided into more components as may serve a particular implementation. As an illustrative example, the components may be implemented on different server devices of the cloud service provider.

Moreover, the components of the system 100 may include hardware, software, or both. For example, the components of the system 100 may include one or more instructions stored on a computer-readable storage medium and executable by processors of one or more computing devices. When executed by the one or more processors, the computer-executable instructions of one or more computing devices can perform one or more methods described herein. Alternatively, the components of the system 100 may include hardware, such as a special purpose processing device to perform a certain function or group of functions. Additionally, or alternatively, the components of the system 100 may include a combination of computer-executable instructions and hardware.

System 100 may allow the users 102 to easily define business processes 12 of interest by providing an interactive process in creating the business process definitions 14. The system 100 may allow the users 102 to get a variety of metrics that quantify process cost for the specified business process 12. System 100 may also provide capabilities to refine and/or streamline the business processes 12 for efficiency. As such, system 100 may allow the users 102 to be more operationally efficient.

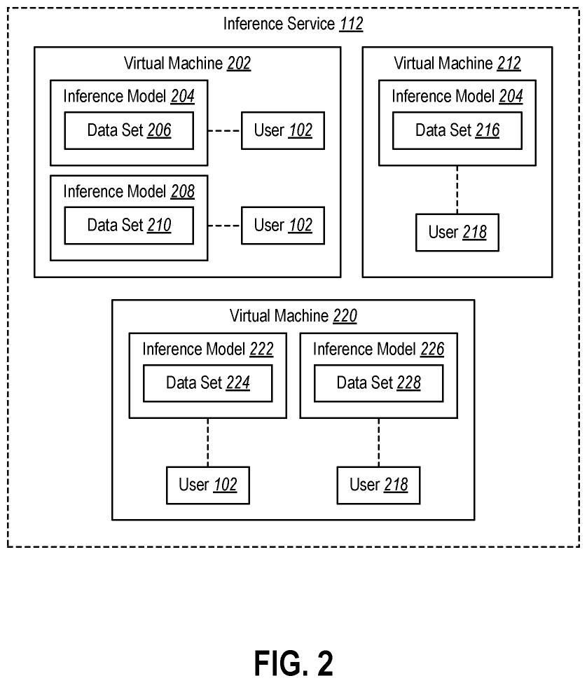

Referring now to FIG. 2, illustrated is an example inference service 112 for use with system 100. The inference service 112 may be implemented by the cloud service provider for system 100 and may include any number of node clusters of the cloud service provider. The node clusters may be grouped by geographic location (e.g., a region of node clusters). The node clusters may also be implemented across multiple geographic locations (e.g., at different datacenters including one or multiple node clusters). Each of the node clusters may include a variety of server nodes having a number and variety of compute cores thereon. In addition, one or more virtual machines 202, 212, 220 may be implemented on the compute cores of the server nodes. Some or all the compute cores may include virtual machine(s) 202, 212, 220 implemented thereon.

The virtual machines 202, 212, 220 may be used to host one or more inference models (inference models 204, 208, 214, 222, 226) associated with different datasets (datasets 206, 210, 216, 224, 228). The virtual machine 202 may the host inference model 204 associated with the dataset 206 and the inference model 208 associated with the dataset 210. In addition, the inference models 204 and 208 may be associated with the same user or company (e.g., user 102). As such, the datasets 206, 210 may use the collaboration data 32 from the same user or company.

The virtual machine 212 may host the inference model 214 associated with dataset 216. The dataset 216 may be associated with a different user or company (e.g., user 218). As such, the dataset 216 may use the collaboration data 32 from a different user or company than datasets 206, 210. The virtual machine 220 may host the inference model 222 associated with the dataset 224 and the inference model 226 associated with the dataset 228. The dataset 224 may be associate with one user or company (e.g., the user 102) and the dataset 228 may be associate with a different user or company (e.g., the user 218). As such, the virtual machine 220 may host the inference models 222, 226 used by different users 102, 218.

While three virtual machines 202, 212, 220 are illustrated any number of virtual machines may be part of inference service 112. For example, the inference service 112 may host over 50,000 different inference models. Moreover, each virtual machine 202, 212, 220 may host any number of inference models 204, 208, 214, 222, 226. In some implementations, the inference service 112 may distribute the inference models 204, 208, 214, 222, 226 between the different virtual machines 202, 212, 220 to balance the workload of the virtual machines 202, 212, 220.

Each user 102, 218 may have multiple inference models 204, 208, 214, 222, 226 hosted by the virtual machines 202, 212, 220. The inference models 204, 208, 214, 222, 226 may be loaded on demand when needed to provide interactive capability when creating different business process definitions 14. The inference service 112 may ensure that the inference models 204, 208, 214, 222, 226 are always hosted on the same virtual machine 202, 212, 220 the inference model 204, 208, 214, 222, 226 was first hosted on so that any subsequent request for the inference models 204, 208, 222, 226 are routed to the appropriate virtual machine 202, 212, 220. Loading the inference models 204, 208, 214, 222, 226 on demand, helps eliminate the huge model load times and provides a way for real time inferences.

The inference service 112 may include a manager, such as, but not limited to Kubernetes, to manage the different virtual machines 202, 212, 220 where the inference models 204, 208, 214, 222, 226 are loaded and manage different requests for the inference models 204, 208, 214, 222, 226. The manager service may ensure that each users 102, 218 data is handled separately. Within a single user 102, 218, there may be multiple inference models 204, 208, 214, 222, 226 that are available at one time. The manager service may ensure that the requests for the datasets 206, 210, 216, 224, 228 are routed to the virtual machine 202, 212, 220 hosting the inference model 204, 208, 214, 222, 226 for the requested dataset. In addition, the manager service may ensure that any future request for the datasets 206, 210, 216, 224, 228 are routed to the appropriate virtual machine 202, 212, 220. The manager may ensure that stateful routing occurs to the different virtual machines 202, 212, 220.

As such, the inference service 112 enables interactive, real-time, on demand inference machine learning model loads at low cost with stateful routing.

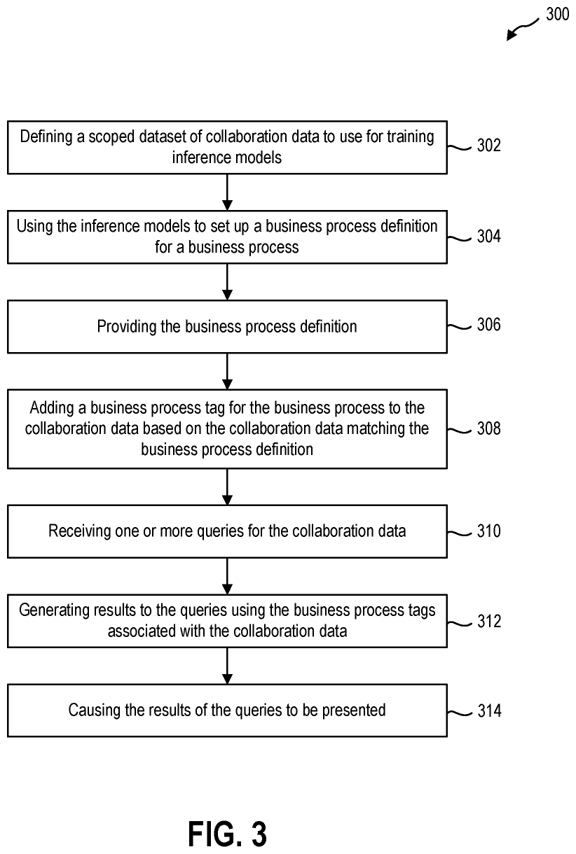

Referring now to FIG. 3, illustrated is an example method 300 for use with system 100 (FIG. 1) for business process analysis. The actions of method 300 may be discussed below with reference to the architectures of FIGS. 1 and 2.

At 302, method 300 may include defining a scoped dataset of collaboration data to use for training inference models. The user 102 may use the user interface 25 to define one or more scoped datasets 10 of the collaboration data 32. The collaboration data 32 may be stored in a datastore 108 on a per user basis, and thus, the scoped datasets 10 may only use the collaboration data 32 for the user 102. The user may use the web service platform 104 to define a taxonomy to aid in collaboration data 32 classification for the scoped dataset 10. For example, the user 102 may specify which classification data 32 to include in the scoped dataset 10 and/or which classification data 32 to exclude from the scoped dataset 10. The datasets 10 define what collaboration data 32 to use as input data for training inference models 34 to provide related words 22. By defining a scoped dataset to use for training the inference models 34, the user 102 may drive relevant and/or targeted process analysis.

The collaboration data 32 may be classified based on the classification choices of the user 102 for the scoped dataset 10 and the collaboration data 32 may be filtered based on the definition provided by the user 102 for the scoped dataset 10. In some implementations, the filtering of the classification data 32 may evolve by using, for example, a machine learning algorithm or system that learns the classification of the collaboration data 32 based on the definition provided by the user 102 for the dataset 10 over time.

The scoped dataset 10 may be important for local or targeted analysis. For example, the user 102 may be a divisional analysis interested in analyzing the collaboration data 32 of the division (sales, accounting, human resources, etc.). As such, the user 102 may select a targeted dataset 10 with filtered collaboration data 28 that covers the division. One example of the scoped dataset 10 is categorizing meetings across meeting purpose and/or intent, such as, training, product planning, hiring, etc. to understand how organizations are spending time in meetings. Another example of the scoped dataset 10 may include categorizing meetings and emails across back-office business processes 12, such as, procurement, customer support, etc. to understand how much resources (people, time) the business processes 12 are taking.

The scoped dataset 10 may be provided as input to a machine learning component 110 that uses the scoped dataset 10 to train one or more machine learning inference models 34 using the scoped dataset 10. The inference models 34 may be used to provide related words for the dataset 10.

At 304, method 300 may include using the inference models to set up a business process definition for a business process. The user 102 may use the user interface 25 to setup a business process definition 14 for the business process 12. The user 102 may select a scoped datasets 10 to use in creating the business process definition 14 for the business process 12.

The user 102 may specify one or more seed words or phrases to describe the business process 12. The user 102 may use predefined templates for different business processes 12 (e.g., templates with common key words or phrases that describe a business process 12) as a starting point for the seed words or phrases, or the user 102 may start from scratch (e.g., provide an initial seed word or phrase to describe the business process 12). In addition, the user 102 may decide to limit the business process definition 14 to a type of collaboration data 32 (e.g., only include information obtained from calendar data for meetings about the business process, only include information obtained from the calendar data and documents created for the business process, only include instant messages and e-mails, etc.).

By the user 102 specifying a list of keywords or phrases (a combination of keywords), the vocabulary for the business process 12 is setup. As each keyword or phrase is entered, the web service platform 104 automatically shows related words 22 or phrases culled from the filtered set of collaboration data 28 for the identified datasets 10. The web service platform 104 may also present the coverage information 20 for the related words 22 (e.g., how many electronic meeting invites and/or calendar information include the related words 22, how many emails include the related words 22 in the subject line of the e-mails and/or the body of the e-mails, etc.). The user 102 may pick and choose from the list of related words 22 and add to the vocabulary for the business process definition 14.

As the vocabulary builds up for the business process definition 14, the web service platform 104 provides an updated view of the coverage information 20 (e.g., how much content is covered as part of the business process definition 14 and what content may be remaining). The user 102 may decide to continue adding more keywords or phrase to the business process definition 14 using the updated view of the coverage information 20.

In some implementations, for each keyword or phrase added to the business process definition 14, the web service platform 104 may also shows a list of condensed subjects across meetings and emails (e.g., a top 10 list of the condensed subjects).

The user 102 may also select to have certain keywords or phrases excluded from the vocabulary of the business process definition 14. The user interface 25 may also show the coverage information 20 as to how much content might be excluded with the removal of the words or phrases from the business process definition 14.

In some implementations, the user 102 may request to look at sample data for a specific keyword or phrases. The web service platform 104 may provide sample collaboration data 32 corresponding to the words or phrases included in the business process definition 14. The user 102 may use the samples to verify the classification of the collaboration data 32 and make any changes as necessary to the classification of the collaboration data 32, resulting in the fine tuning of the classification of the collaboration data 32.

At 306, method 300 may include providing the business process definition. The user 102 may use the web service platform 104 to publish the business process definition 14 so that the business process definition 14 may be used for analysis. The business process definition 14 may also be saved in the datastore 118.

At 308, method 300 may include adding a business process tag for the business process to the collaboration data based on the collaboration data matching the business process definition. Once the business process definition 14 is created for a business process 12, the workflow executor component 106 may automatically tag the collaboration data 32 with business process tags 30 for the business process 12. When a match occurs between words or phrases in the business process definition 14 and the collaboration data 32, a business process tag 30 for the business process 12 is associated with the collaboration data 32.

At 310, method 300 may include receiving one or more queries for the collaboration data. The user 102 may use the user interface 25 to create one or more queries 26 for the collaboration data. The user 102 may generate one or more queries 26 for a business process 12. The queries 26 may identify the business process definitions 14 for the business process 12. In addition, the queries 26 may exclude different business process definitions 14 and/or business processes 12 from the analysis. For example, the user 102 may create a query 26 to identify how much time the company is spending in meetings planning events. As such, the queries 26 may be customized for a specific topic or group of individuals.

At 312, method 300 may include generating results to the queries using the business process tags associated with the collaboration data. The business process tags 30 may be used to generate results 24 to the queries 26. The user 102 may use the results 24 to analyze the impact of the business process 12 to the company or a department within the company. The business process tag 30 may allow the user 102 to filter the collaboration data 32 by, for example, individuals, business processes, time frames, collaboration data types (meeting, e-mails, documents, instant messaging), optimizations based on the query 26.

The web service platform 104 may communicate the query 26 and the business process and/or the identified business process definitions 14 for the query 26 to the workflow executor component 106. The workflow executor component 106 may use the business process tags 30 to identify which collaboration data 32 is related to the identified business process definitions 14 in the queries 26 and provide the identified collaboration data 32 to the web service platform 104.

At 314, method 300 may include causing the results of the queries to be presented. The web service platform 104 may present the results 24 to the query 26 (e.g., the identified collaboration data 32 received from the workflow executor component 106 or other metrics associated with the identified collaboration data 32) using the user interface 25. The results 24 may be presented to the user 102 and/or the results 24 may be stored in the datastore 118 for future analysis or use. The results 24 may provide the user 102 an overview of the collaboration time spent on a business process 12.

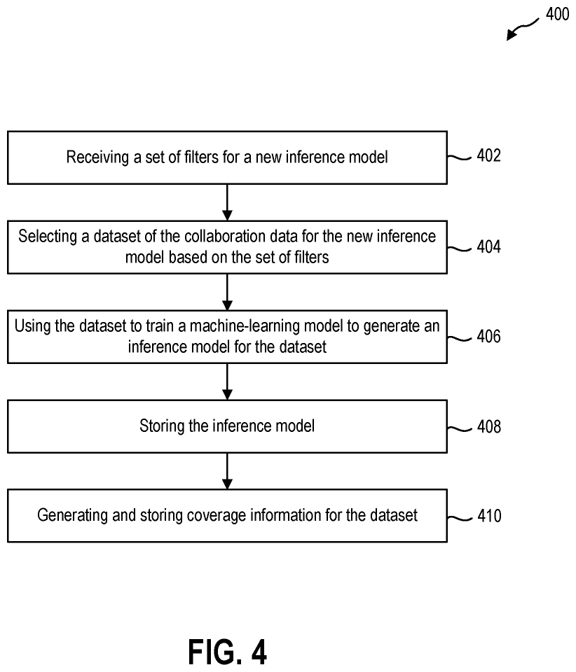

Referring now to FIG. 4, illustrated is an example method 400 for creating a dataset 10 (FIG. 1) for use with business process analysis. The actions of method 400 may be discussed below with reference to the architectures of FIGS. 1 and 2.

At 402, method 400 may include receiving a set of filters for a new inference model 402. The set of filters may narrow down the collaboration data 32 to a specific topic (e.g., a business process 12) and/or a context. Examples of the filters may include an organization within a company (e.g., limit to sales) and/or a time frame (e.g., last four months). The set of filters may be used to identify which collaboration data 32 to use as input for training inference models 34 to provide related words 22 for use in creating the business process definitions 14.

At 404, method 400 may include selecting a dataset of the collaboration data for the new inference model based on the set of filters. The workflow executor component 106 may receive the set of filters and may create a dataset 10 with a set of filtered collaboration data 28 that corresponds to the set of filters. The set of filtered collaboration data 28 may also include customized stop word removal and/or token cleansing specific for collaboration data. As such, the filtered collaboration data 28 may be customized to the dataset 10.

At 406, method 400 may include using the dataset to train a machine-learning model to generate an inference model for the dataset. The workflow executor component 106 may send the dataset 10 and the filtered collaboration data 28 to the machine learning component 110 to use as input data in training one or more machine learning inference models 34. By providing a well-defined dataset 10 for training data for the inference models 34, the inference models 34 may produce more accurate and/or tailored results. The machine learning component 110 may generate one inference model 34 for each dataset 10. As such, the inference models 34 may be customized to the context of the corresponding dataset 10.

In an implementation, the inference model 34 is a trained machine learning model customized for the filtered collaboration data 28 of the dataset 10. Examples of the machine learning model include, but are not limited to, word2vec models, sent2vec models, (Bidirectional Encoder Representations from Transformers) BERT models, and/or Embeddings from Language Models (ELMO). The inference model 34 may be trained to find related words (bigrams included). The machine learning component 110 may use various techniques to train the inference models 34 to merge results of the related words and rank the results based on words selected by the user 102 during the business process definition 14 creation. In addition, the machine learning component 110 may use customized noise reduction techniques specific to human curated collaboration data 32 and a custom way to prioritize results based on how and when a word was added into the business process definition 14.

At 408, method 400 may include storing the inference model. The inference models 34 generated by the machine learning component 110 may be stored in one or more datastores 116. In an implementation, an association between the corresponding dataset 10 may be stored in the datastore 116 with the inference model 34. As new datasets 10 are created, new inference models 34 may be created by the machine learning component 110 for the new datasets 10. As such, separate machine learning inference models 34 for different context and/or different scoped datasets 10 may be stored in datastore 116.

At 410, method 400 may include generating and storing coverage information for the dataset. The coverage information 20 may provide information on how frequently a word and/or phrase is used in the collaboration data 32. The workflow executor component 106 may be used to determine the coverage information 20. For example, the workflow executor component 106 processes information from the collaboration data 32, such as, but not limited to, a number of electronic meeting invites for the business process 12, calendar information (e.g., an amount of time scheduled for the meetings), and/or similar metrics to provide an indication on how frequently a word and/or phrase is used in the collaboration data 32. The coverage information 20 may be stored in a datastore 114. The coverage information 20 may assist the user 102 in creating better business process definitions 14 by allowing the user to select and/or exclude words based on the amount of collaboration data 32 that may be included and/or excluded from the analysis.

As such, method 400 may be used to identify scoped datasets 10 for use with training one or more inference models 34 and enables the user 102 to define a scoped dataset to use for training, to drive relevant and/or targeted process analysis.

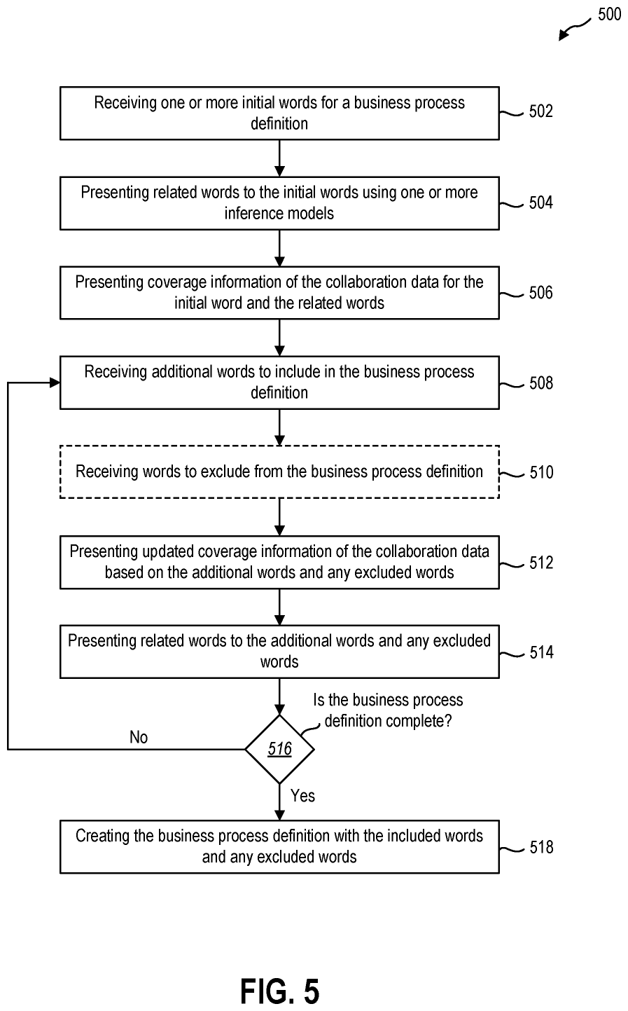

Referring now to FIG. 5, illustrated is an example method 500 for creating a business process definition 14 (FIG. 1) for a business process 12 (FIG. 1). The actions of method 500 may be discussed below with reference to the architectures of FIGS. 1 and 2.

At 502, method 500 may include receiving one or more initial words for a business process definition. A business process definition 14 is as a collection of words or phrases that describe a business process 12. Any collaboration activity or items that contain the words of the business process 12 may belong to the business process definition 14. The user 102 may provide an initial seed word or phrases to describe a business process 12 using, for example, the user interface 25.

In an implementation, the user 102 may use a template or predetermined set of seeded words that describe the business process 12 and/or a category of the business process 12 as the initial words for the business process definition 14. The predetermined set of seed words may enable the user 102 to quickly identify words for describing the business process 12. For example, one such category is “Administrative” which may have a set of seed words including “change password”, “time sheet”, “timesheet”, and “workday time.” The user 102 may select one or more words from the set of seed words as the initial words for the business process definition 14. In addition, the user 102 may select different words to add as the initial words or phrases to describe the business process 12 other than the set of predetermined seed words. In addition, the user 102 may add additional words to the set of predetermined seed words to describe the business process 12.

At 504, method 500 may include presenting related words to the initial words using one or more inference models. As the user 102 enters in the initial words or phrases, the user interface 25 may present a list of related words 22 to the initial words. The user 102 may be able to expand the list of related words 22 to see additional words and/or phrases. In addition, the list of related words 22 may indicate a rank indicating how similar or close the related words 22 are to the initial words or phrases. The list of related words 22 may be provided by the inference models 34 associated with the datasets 10 selected for creating the business process definition 14. By using inference models 34, a hint via a single keyword may help uncover numerous related keywords, that may have been difficult or impossible to uncover manually.

At 506, method 500 may include presenting coverage information of the collaboration data for the initial word and the related words. The user interface 25 may also present coverage information 20 for the related words 22. The coverage information 20 may provide information on the amount of collaboration data 32 that includes the related word 22. For example, the coverage information 20 may provide information about how many meeting invites include the related word 22. Another example of the coverage information 20 includes information about the number of hours spent in meetings that included the related word 22.

At 508, method 500 may include receiving additional words to include in the business process definition. The user 102 may select one or more related words 22 to add to the business process definition 14. In addition, the user 102 may add one or more words directly to the business process definition 14 (e.g., the user 102 may not use the related words 22).

At 510, method 500 may optionally include receiving words to exclude from the business process definition. The user 102 may select one or more of the related words 22 to exclude from the business process definition 14. In addition, the user 102 may add one or more words directly to exclude from the business process definition 14.

At 512, method 500 may include presenting updated coverage information of the collaboration data based on the additional words and any excluded words. The coverage information 20 may be automatically updated as the user 102 selects new words for the business process definition 14 and/or removes words from the business process definition 14. The web service platform 104 provides an updated view of the coverage information 20 (e.g., how much content is covered as part of the business process definition 14 with the added words and what content may be remaining) as words are added and/or removed from the business process definition 14.

At 514, method 500 may include presenting related words to the additional words and any excluded words. A new set of related words 22 and/or updated related words 22 may be suggested by the inference models 34 based on the current set of included words 16, the current set of excluded words 18, and the initial words or phrases for the business process definition 14. When the user 102 enters or adds multiple words to the business process definition 14 and/or excludes words from the business process definition 14, the inference models 34 may iteratively navigate to more custom words to provide as related words 22.

The inference models 34 may use custom weights for user entered words as compared to system suggested related words 22. In addition, the inference models 34 may use custom weights for words entered towards the end of the business process definition 14 creation process. As such, the related words 22 may improve or become more targeted to a specific business process 12 as the weights are applied during the iterative process of selecting and/or removing words from the business process definition 14. The inference models 34 may also provide a streamlined experience without noisy content, enabling an effective process definition capture. The web service platform 104 may present an updated set of related words 22 for the new set of words or phrases defining the business process 12.

At 516, method 500 may include determining whether the business process definition is complete. The user 102 may review the set of words and the coverage information 20 to determine whether to add any more words to the business process definition 14 and/or exclude words from the business process definition 14. If the user 102 determines that the business process definition 14 is not complete (e.g., the user 102 wants to add or remove words), method 500 may return to 508 and repeat.

At 518, method 500 may include creating the business process definition with the included words and any excluded words. If the user 102 feels there are sufficient words and coverage for the business process definition 14, the user 102 may create the business process definition 14 with the set of included words 16 and any excluded words 18. One example business process definition 14 may have included words 16 “phone screen”, “interview loop”, “information” and may have excluded words 18 “customer.” The business process definition 14 may be saved in datastore 118 and/or may be submitted to other applications or components of system 100 for use.

As such, method 500 may provide an interactive process for building business process definitions 14 by providing related words 22 for the business process 12 on demand as the user 102 adds and/or removes words from the business process definition 14. With this automated interactive approach, a business process 12 may be captured more accurately and comprehensively.

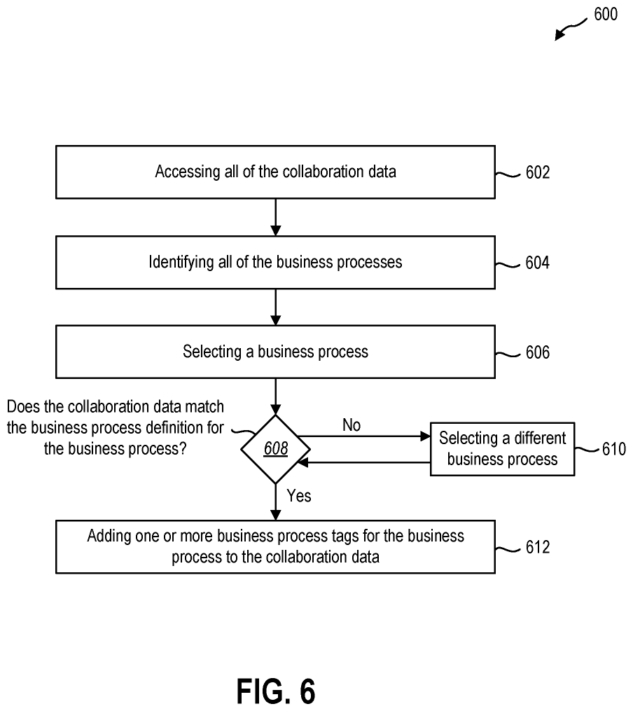

Referring now to FIG. 6, illustrated is an example method 600 for tagging collaboration data 32 (FIG. 1) with one or more business process tags 30 (FIG. 1). The actions of method 600 may be discussed below with reference to the architectures of FIGS. 1 and 2.

At 602, method 600 may include accessing all of the collaboration data. The workflow executor component 106 may access all of the collaboration data 32 for the user 102. For example, the workflow executor component 106 may access the collaboration data 32 at a set time (e.g., access the collaboration data weekly). Another example may include the workflow executor component accessing the collaboration data 32 when new collaboration data 32 is received by the system 100.

At 604, method 600 may include identifying all business processes, and at, 606, method 600 may include selecting a business process. The workflow executor component 106 may access all of the business processes 12 for the user 102. The workflow executor component 106 may select one business process 12 to compare to the collaboration data 32.

At 608, method 600 may include determining whether the collaboration data matches the business process definition for the business process. The workflow executor component 106 may compare words from the collaboration data 32 with the included words 16 in the business process definition 14 for the business process 12 to determine whether any of the words match (e.g., are the same and/or are similar).

At 610, the method may include selecting a different business process. If a match does not occur between the words or phrases in the business process definition 14 and the collaboration data 32, the workflow executor component 106 may select a different business process 12 of the user 102, and method 600 may return to 608.

At 612, the method may include adding one or more business process tags for the business process to the collaboration data. If a match occurs between the words or phrases in the business process definition 14 and the collaboration data 32, the workflow executor component 106 may tag, or otherwise associate, a business process tag 30 to the collaboration data 32. The business process tag 30 may be used to identify which collaboration data 32 may be related to the business process 12. The business process tags 30 may be stored with the collaboration data 32 in the datastore 108.

If the collaboration data 32 matches more than one business process definition 14 (e.g., words from the collaboration data 32 match the included words 16 in the business process definition 14), the collaboration data 32 may be tagged with more than one business process tags 30. As such, a single collaboration data (e.g., a single item) may be tagged with multiple business process tags 30 identifying the collaboration data 32 as belonging to multiple business processes 12.

An example use case may include a business process definition 14 with included words 16 “phone screen”, “interview loop”, “information” and excluded words 18 “customer.” Collaboration data 32 for a meeting with subject “Person X phone screen” is tagged with a business process tag 30 for the business process definition 14 to identify the collaboration data 32 as belonging to the business process definition 14. However, collaboration data 32 for a meeting with a subject “Customer Interview” does not belong to the business process definition 14 because of the excluded words and included words selected, and thus, is not tagged as belonging to the business process.

Method 600 may return to 606 and may repeat until all business processes 12 of the user 102 have been compared to the collaboration data. As such, method 600 may be used to identify which collaboration data 32 for the user 102 belongs to different business processes 12.

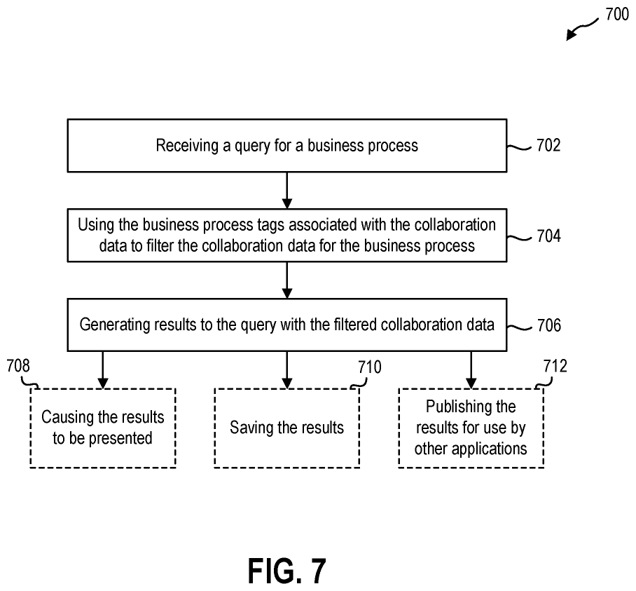

Referring now to FIG. 7, illustrated is an example method 700 for generating query results 24 (FIG. 1) for one or more queries 26 (FIG. 1). The actions of method 700 may be discussed below with reference to the architectures of FIGS. 1 and 2.

At 702, method 700 may include receiving a query for a business process. The user 102 may access the web service platform 104 to provide one or more queries 26 for a specific business process 12, topic, and/or question. The web service platform 104 may provide a flexible query system that allows the user 102 to filter the queries 26 by, for example, individuals, business processes, time frames, collaboration data types (meeting, e-mails, documents, instant messaging), and/or other optimizations. The queries 26 may identify the business process definitions 14 for the business process 12. In addition, the queries 26 may exclude different business process definitions 14 and/or business processes 12 from the analysis. For example, the user 102 may create a query 26 to identify how much time the company is spending in meetings planning events.

At 704, method 700 may include using the business process tags associated with the collaboration data to filter the collaboration data for the business process. The business process tags 30 may be used to generate results 24 to queries 26. The web service platform 104 may communicate the query 26 and the business process and/or the identified business process definitions 14 for the query 26 to the workflow executor component 106. The workflow executor component 106 may use the business process tags 30 to identify which collaboration data 32 is related to the identified business process definitions 14.

At 706, method 700 may include generating results to the query with the identified collaboration data. The workflow executor component 106 may provide the identified collaboration data 32 to the web service platform 104 as part of the generated results 24. The results 24 may include other collaboration information, such as, but not limited to, statistics around collaboration or a variety of metrics that quantify process cost for the specified process.

At 708, method 700 may optionally include causing the results to be presented. The web service platform 104 may present the results 24 to the user 102. The results 24 may provide the user 102 an overview of the collaboration time spent on a business process 12. The results 24 may also help the user 102 understand how much collaboration happened for a specific business process 12. The user 102 may analyze the results 24 to understand the impact of the business process 12 to the company or an organization within the company.

At 710, method 700 may optionally include storing the results. The web service platform 104 may store the results 24 in a datastore 118 for future use and/or analysis.

At 712, method 700 may optionally include publishing the results for use by other applications. The web service platform 104 may send the results to other components within the system 100 (e.g., workflow executor component 106) or other applications within the system 100 to use.

One example use case may include the user 102 accessing the web service platform 104 to create a meeting and person query 26. The user 102 may indicate to include meetings for Process A and to exclude meetings for Process B in the query 26. The query 26 may execute in the background and may filter the collaboration data 32 using the business process tags 30. The query results 24 for the query 26 may include a file generated with the identified collaboration data 32 and other collaboration information, such as, but not limited to, statistics around collaboration or a variety of metrics that quantify process cost for the specified process.

Method 700 may be used to provide the user 102 with query results 24 that quantifies the business process 12 into numbers that may convey how much the business process 12 cost (e.g., the amount of hours spent on the business process or the cost dollars (rate per person per hour) and provides a baseline for the business process 12.

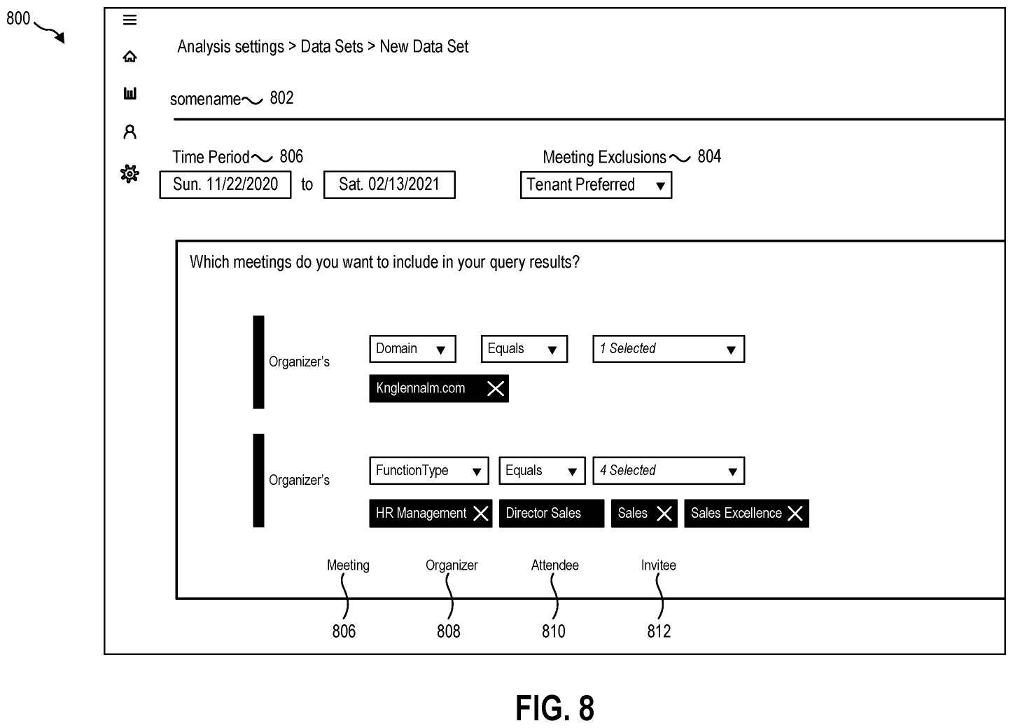

Referring now to FIG. 8, illustrated is an example GUI screen 800 for creating a new dataset 10 (FIG. 1). The user 102 (FIG. 1) may access the GUI screen 800 to create a new dataset 10 using, for example, a dashboard or portal on the web service platform 104 (FIG. 1). The user provides a name 802 for the new dataset 10. The name 802 may be used to identify different datasets available for a company associated with the user 102 to use in creating one or more business processes definitions 14 (FIG. 1). The user may customize the new dataset 10 by specifying one or more filters that define which collaboration data 32 to include in the new dataset 10.

The user 102 may select a time period 806 for the collaboration data 32 (FIG. 1) to include in the new dataset 10. For example, the user may want to limit the collaboration data 32 to data for a specified time period (e.g., the past three months). The user may also provide one or more meeting exclusions 804 to filter out of all analysis performed using the dataset 10. Meeting exclusions 804 may include any information or collaboration data 32 to exclude from the analysis of the dataset 10. One example of meeting exclusions 804 may include doctor appointments or other personal appointments. Another example of meeting exclusions 804 may include holidays or out of office meetings.

In addition, the user may select which collaboration data 32 (e.g., e-mails, meetings, documents, instant messages) to include in the new dataset 10. The user may, for example, specify only meetings 807 to include in the new dataset 10. Another example may include adding meetings 807, e-mails, and documents to the dataset 10. The user may also specify other information for collaboration data 32 to include in the dataset 10. If the collaboration data 32 is a meeting, the user may specify the organizer 808 of the meeting, attendees 810 of the meeting, and/or invitees 812 of the meeting. For example, the user may specify to only include collaboration data 32 from the sales team of the company and human resource (HR) management of the company in the dataset.

The new dataset 10 may be defined based on the collaboration data 32 to include and/or exclude from the dataset 10. As such, the scope of the new dataset 10 may be limited to the filters and/or selections provided by the user 102. The datasets 10 define what subset of collaboration data 32 to use as input data for training inference models 34.

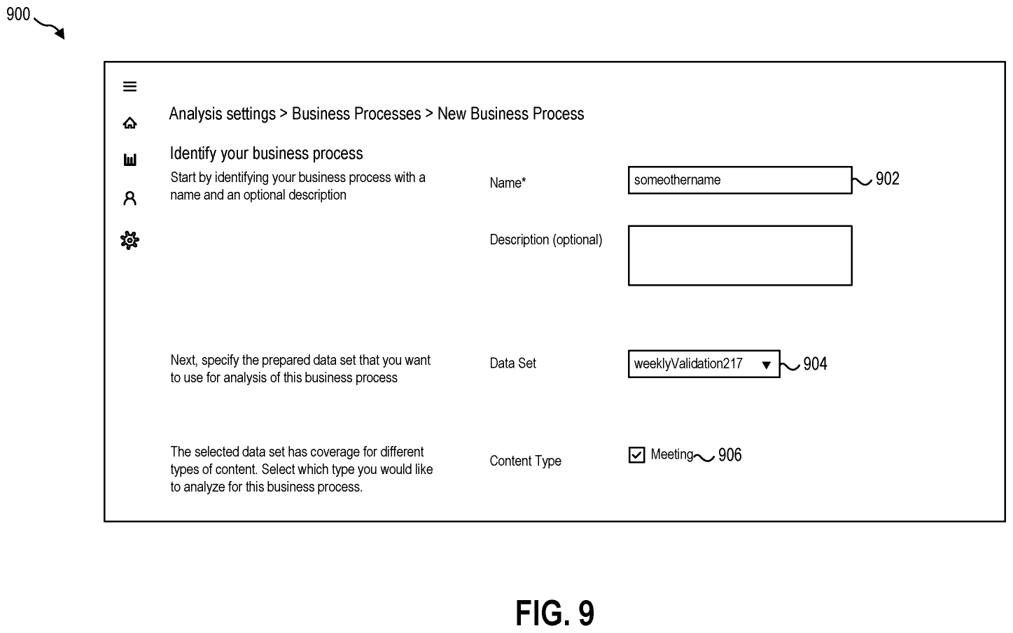

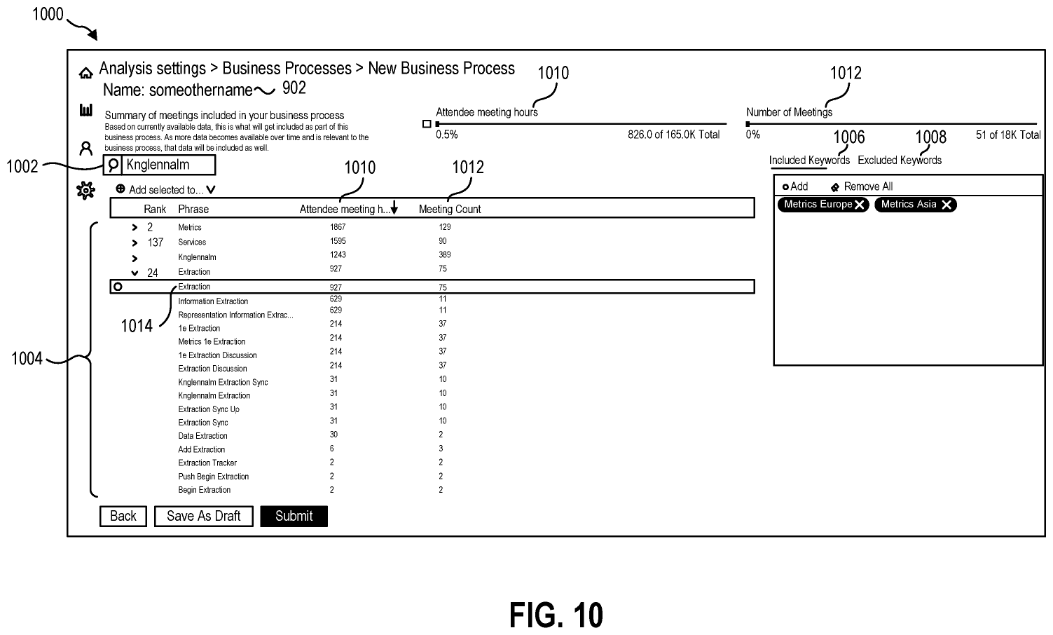

Referring now to FIGS. 9 and 10, illustrated are example GUI screens 900 and 1000 for creating a new business process definition 14 (FIG. 1) for a business process 12 (FIG. 1). The user 102 may access GUI screens 900 and 1000 through a dashboard or portal on the web service platform 104 (FIG. 1). The user 102 may provide a name 902 for the new business process definition 14 and/or a description of the new business process definition 14. The description may provide details and/or information for the business process 12.

The user 102 may select a dataset 904 to use in creating the business process definition 14. For example, a dropdown list may show the dataset names 802 (FIG. 8) of the different datasets 10 created and/or available for use. The user 102 may select one or more datasets 904, or scoped down collaboration data 32, to use in creating the business process definition 14. In addition, the user 102 may specify a content type 906 of collaboration data 32 (FIG. 1) to include in the business process definition 14. For example, the content type 906 may be meetings, e-mails, instant messaging, and/or documents.

Once the user 102 specifies the dataset(s) 904 to use for the business process, GUI screen 1000 may be displayed to guide the user in selecting words to include and/or exclude from the business process definition 14 using the inference models 34 associated with the selected dataset(s) 904.

The name 902 of the business process definition 14 is displayed and the user 102 may provide an initial word 1002 or set of words describing the business process 12 to include in the business process definition 14. A list of related words 1004 may be generated by the inference model 34 for the initial word 1002 or set of words and displayed on GUI screen 1000. The list of related words 1004 may filter out noise, such as, but not limited to, soft words, unrelated words, meaningless bigrams, dates, names, and/or months to keep the list of related words 1004 to words associated with the business process 12.

The user 102 may select one or more words 1006 from the list of related words 1004 to include in the business process definition 14. In addition, the user 102 may select one or more words 1008 to exclude from the business process definition 14. For example, the user may include three additional words in addition to the initial word to add to the business process definition 14. As the user 102 adds words 1006 to the business process definition 14 and/or removes words from the business process definition, the inference model 34 may update the list of related words 1004 based on the new set of words for the business process.

Building the business process definition 14 may be an iterative process where the list of related key words 1004 are updated based on words selected by the user 102 (e.g., the four words included in the business process definition). As such, as the user 102 continues through the process of selecting and/or removing words from the business process definition 14, the list of related key words 1004 may improve and become closer to the business process 12.

In addition, GUI screen 1000 may provide coverage information 20 for the selected words in the business process definition 14. Coverage information 20 may include attendee meeting hours 1010 (e.g., a number of hours scheduled for meetings discussing the business process) and/or a number of meetings 1012 scheduled for the business process. The coverage information 20 may be presented for each related word included in the list of related words 1004. In addition, a summary of the coverage information 20 may be presented for the selected words in the business process definition 14. For example, for the selected four words in the business process definition 14, the organization is spending 826 hours in meetings in 51 meetings. The coverage information 20 is updated as the user 102 selects new words for the business process definition 14 and/or removes words from the business process definition 14. For example, if the user selects to add related word 1014, the attendee meeting hours 1010 will increase by 927 hours and the meeting count 1012 will increase by 75 meetings. The user 102 can use the coverage information 20 to quickly view the amount of collaboration data covered by the business process definition 14.

As such, GUI screen 1000 may provide the user 102 with an interactive process to narrow down the business process definition 14 based on the selected words, the words to exclude, and/or the coverage information 20.

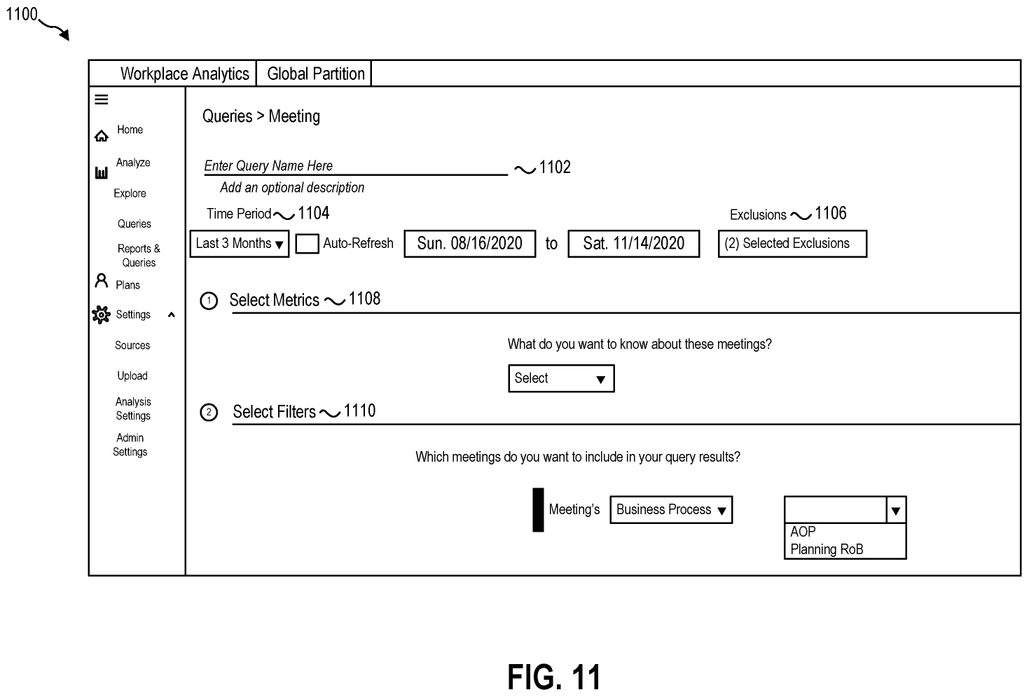

Referring now to FIG. 11, illustrated is an example GUI screen 1100 for generating one or more queries 26 (FIG. 1) by a user 102. The user 102 may access GUI screen 1100 through a dashboard or portal on the web service platform 104 (FIG. 1).

The user 102 may enter in a query name 1102 for the query and may enter in a time period 1104 for the query 26. The user 102 may also select any exclusions 1106 from the query 26. The queries 26 may be a recurring query 26 that runs at a set time (e.g., every week) or a query 26 may be a query 26 that is executed once.

The user 102 may select metrics 1108 to include in the query 26. For example, the user 102 may want to look at the count of attendees for meetings and the count of attendees with conflicting meetings for the business process 12. The user 102 may select one or more filters 1110 for the query 26. For example, the user 102 may say only look at meetings that belong to a specific business process 12. The user 102 may also add organizational data to the query 26. The query 26 may generate results 24 based on the selected time period 1104, exclusions 1106, selected metrics 1108, and/or selected filters 1110.

GUI 1100 may provide the user 102 with a flexible query platform that allows the user 102 to generate targeted results to a specific business process 12 and/or a specific question (e.g., how many hours an individual spent collaborating on a project).

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, embodiments of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

What is claimed is:

1. A system comprising,
a memory to store data and instructions;
at least one processor operable to communicate with the memory, wherein the at least one processor is operable to:
receive at least one initial word that describes a business process to include in a business process definition for the business process;
present, via a user interface, related words for the business process, wherein the related words are received from an inference model that is accessed in response to a selection of a dataset of filtered collaboration data to use in creating the business process definition;
present, via the user interface, coverage information that identifies an amount of collaboration data that includes the related words and the at least one initial word;
receive one or more additional words from the related words to include in the business process definition; and
generate and store the business process definition with a set of included words that describe the business process, wherein the set of included words includes the at least one initial word and the one or more additional words.

2. The system of claim 1, wherein the inference model is hosted on a virtual machine of the system and the inference model is loaded into the virtual machine in response to the selection of a dataset.

3. The system of claim 1, wherein the at least one processor is further operable to:
train the inference model to identify related words for the business process within a context of the filtered collaboration data using the dataset with the filtered collaboration data as input data to the inference model.

4. The system of claim 1, wherein the collaboration data includes human generated collaboration data received from different collaboration activities within a company and the at least one processor is further operable to:
train the inference model to use a customized noise reduction specific to the human generated collaboration data to reduce noise in the related words.

5. The system of claim 1, wherein the coverage information includes at least one of information with how many meetings include the related words and the at least one initial word or information with a number of hours scheduled for meetings that include the related words and the at least one initial word.

6. The system of claim 1, wherein the at least one processor is further operable to:
present updated related words for the business process received from the inference model based on the one or more additional words and the at least one initial word;
present updated coverage information that identifies a new amount of the collaboration data that includes the one or more additional words, the updated related words, and the at least one initial word;
receive a selection of another word from the updated related words to include in the business process definition; and
update the set of included words to include the another word, the at least one initial word, and the one or more additional words.

7. The system of claim 6, wherein the at least one processor is further operable to train the inference model to:
apply a weight that ranks the one or more additional words selected as more relevant words to the business process as compared to the initial word; and
use the weight to determine the one or more updated related words.

8. The system of claim 1, wherein the at least one processor is further operable to:
receive one or more excluded words to remove from the business process definition;
present updated related words for the business process received from the inference model based on the one or more excluded words, the one or more additional words, and the at least one initial word;
present updated coverage information of the collaboration data based on the one or more excluded words, the one or more additional words, and the at least one initial word; and
update the business process definition to include the one or more excluded words.

9. A method for creating a business process definition, comprising:
receiving at least one initial word that describes a business process to include in a business process definition for the business process;
presenting, via a user interface, related words for the business process, wherein the related words are received from an inference model that is accessed in response to a selection of a dataset of filtered collaboration data to use in creating the business process definition;
presenting, via the user interface, coverage information that identifies an amount of collaboration data that includes the related words and the at least one initial word;
receiving one or more additional words from the related words to include in the business process definition; and
generating and storing the business process definition with a set of included words that describe the business process, wherein the set of included words includes the at least one initial word and the one or more additional words.

10. The method of claim 9, wherein the inference model is trained to identify related words for the business process within a context of the filtered collaboration data using the dataset with the filtered collaboration data as input data to the inference model.

11. The method of claim 9, wherein the coverage information includes at least one of information with how many meetings include the related words and the at least one initial word or information with a number of hours scheduled for meetings that include the related words and the at least one initial word.

12. The method of claim 9, wherein the collaboration data includes human generated collaboration data received from different collaboration activities within a company.

13. The method of claim 12, wherein the inference model uses a customized noise reduction specific to the human generated collaboration data to reduce noise in the related words.

14. The method of claim 9, further comprising:
presenting updated related words for the business process received from the inference model based on the one or more additional words and the at least one initial word;
presenting updated coverage information that identifies a new amount of the collaboration data that includes the one or more additional words, the updated related words, and the at least one initial word;
receiving a selection of another word from the updated related words to include in the business process definition; and
updating the set of included words to include the another word, the at least one initial word, and the one or more additional words.

15. The method of claim 14, wherein the inference model:
applies a weight that ranks the one or more additional words selected as more relevant words to the business process as compared to the initial word; and
uses the weight to determine the one or more updated related words.

16. The method of claim 9, further comprising:
receiving one or more excluded words to remove from the business process definition;
presenting updated related words for the business process received from the inference model based on the one or more excluded words, the one or more additional words, and the at least one initial word;
presenting updated coverage information of the collaboration data based on the one or more excluded words, the one or more additional words, and the at least one initial word; and
updating the business process definition to include the one or more excluded words.

17. A method for business process analysis, comprising:
receiving a set of filters that define a dataset of filtered collaboration data;
using the filtered collaboration data as an input to train an inference model to determine related words using the filtered collaboration data;
using the related words from the inference model to create a business process definition for a business process;
adding a business process tag to collaboration data that belongs to the business process based on the business process definition;
generating results to one or more queries for the business process, wherein the results include collaboration data with the business process tag for the business process; and
causing the results for the one or more queries for the business process to be presented, via a user interface, to aid in one or more business processes analysis on the collaboration data.

18. The method of claim 17, wherein the collaboration data includes human generated collaboration data captured from different collaboration activities within a company and the filtered collaboration data is a targeted subset of the collaboration data to drive the one or more business process analysis on the collaboration data.

19. The method of claim 17, wherein the inference model is loaded on demand in response to a request to create the business process definition using the dataset and the interface model provides an interactive capability for creating the business process definition.

20. The method of claim 17, wherein the results provide one or more of estimate process cost of the business process, meeting time spend on the business process, a number of individuals involved with the business process, or a generated workload of the business process.
